(19) United States
(12) Patent Application Publication
(10) Pub. No.: US 2007/0239815 A1
(43) Pub. Date: Oct. 11, 2007

(54) PIPELINE FFT ARCHITECTURE AND METHOD

(75) Inventors: Kevin Stuart Cousineau, Ramona, CA (US); Raghuraman Krishnamoorthi, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 11/696,111

(22) Filed: Apr. 3, 2007

Related U.S. Application Data
(60) Provisional application No. 60/789,453, filed on Apr. 4, 2006.

(51) Int. Cl. G06F 17/14

(52) U.S. Cl. 708/404

(57) ABSTRACT

Techniques for performing Fast Fourier Transforms (FFT) are described. In some aspects, calculating the Fast Fourier Transform is achieved with an apparatus having a memory (610), a Fast Fourier Transform engine (FFTe) having one or more registers (650) and a delayless pipeline (630), the FFTe configured to receive a multi-point input from the main memory (610), store the received input in at least one of the one or more registers (650), and compute either or both of a Fast Fourier Transform (FFT) and an Inverse Fast Fourier Transform (IFFT) on the input using the delayless pipeline.

The present Application for Patent claims priority to Provisional Application No. 60/789,453 entitled “KEEPER FFT BLOCK” filed Apr. 4, 2006, and assigned to the assignee hereof and hereby expressly incorporated by reference herein.

### BACKGROUND

1. Field

The present disclosed embodiments relates generally to signal processing, and more specifically to apparatus and methods for efficient computation of a Fast Fourier Transform (FFT).

2. Background

The Fourier Transform can be used to map a time domain signal to its frequency domain counterpart. Conversely, an Inverse Fourier Transform can be used to map a frequency domain signal to its time domain counterpart. Fourier transforms are particularly useful for spectral analysis of time domain signals. Additionally, communication systems, such as those implementing Orthogonal Frequency Division Multiplexing (OFDM) can use the properties of Fourier transforms to generate multiple time domain symbols from linearly spaced tones and to recover the frequencies from the symbols.

A sampled data system can implement a Discrete Fourier Transform (DFT) to allow a processor to perform the transform on a predetermined number of samples. However, the DFT is computationally intensive and requires a tremendous amount of processing power to perform. The number of computations required to perform an N point DFT is on the order of N², denoted O(N²). In many systems, the amount of processing power dedicated to performing a DFT may reduce the amount of processing available for other system operations. Additionally, systems that are configured to operate as real time systems may not have sufficient processing power to perform a DFT of the desired size within a time allocated for the computation.

The Fast Fourier Transform (FFT) is a discrete implementation of the Fourier transform that allows a Fourier transform to be performed in significantly fewer operations compared to the DFT implementation. Depending on the particular implementation, the number of computations required to perform an FFT of radix r is typically on the order of N×logᵣ(N), denoted as O(Nlogᵣ(N)).

One typical FFT in telecommunications is an FFT of radix 8. Because FFT computation often involves the use of a butterfly core, various point FFTs can be derived using a based computation of the radix-8 FFT. Subsequently, if the radix-8 FFT computation can be computed more efficiently, the benefit carries over to other FFTs that employ a radix-8 FFT butterfly core.

In the past, systems implementing an FFT may have used a general purpose processor or stand alone Digital Signal Processor (DSP) to perform the FFT. However, systems are increasingly incorporating Application Specific Integrated Circuits (ASIC) specifically designed to implement the majority of the functionality required of a device. Implementing system functionality within an ASIC minimizes the chip count and glue logic required to interface multiple integrated circuits. The reduced chip count typically allows for a smaller physical footprint for devices without sacrificing any of the functionality.

The amount of area within an ASIC die is limited, and functional blocks that are implemented within an ASIC need to be size, speed, and power optimized to improve the functionality of the overall ASIC design. The amount of resources dedicated to the FFT can be minimized to limit the percentage of available resources dedicated to the FFT. Yet sufficient resources need to be dedicated to the FFT to ensure that the transform may be performed with a speed sufficient to support system requirements. Additionally, the amount of power consumed by the FFT module needs to be minimized to minimize the power supply requirements and associated heat dissipation. Further, FFT computation speed needs to be optimized because common telecommunication applications require computations to be completed in real-time.

There is therefore a need in the art for techniques to optimize an FFT architecture for implementation within an integrated circuit, such as an ASIC.

### SUMMARY

Techniques for efficient computation of a Fast Fourier Transform (FFT) and Inverse Fast Fourier Transform (IFFT) are described herein.

In some aspects, the computation of I/FFT is achieved with an apparatus having a memory, and a Fast Fourier Transform engine (FFTe) having one or more registers and a delayless pipeline, the FFTe configured to receive a multi-point input from the main memory, store the received input in at least one of the one or more registers, and compute either or both of a Fast Fourier Transform (FFT) and an Inverse Fast Fourier Transform (IFFT) on the input using the delayless pipeline. The computation of either or both of a Fast Fourier Transform (FFT) and an Inverse Fast Fourier Transform (IFFT) on the input may use a gapless pipeline. The FFTe may have a radix-8 butterfly core. The FFTe may have a radix-4 butterfly core. The FFTe may have at least 64 registers. The FFTe may further include complex multipliers, wherein 56 registers of the at least 64 registers receive input from the complex multipliers. 32 registers of the at least 64 registers may receive input from the main memory. The FFTe may be configured to receive a z point multi-point input, wherein z is a multiple of 512. The FFTe may be further configured to output the computed transform. The FFTe may be configured to begin writing the output x cycles after reading the first input, wherein x is 8 plus a pipeline delay. The FFTe may be configured to complete writing the output y cycles after reading the first input, wherein y is 16 plus a pipeline delay. The FFTe may include a first set of adders configured to read a first set of inputs, and the first inputs are bit-reversed prior to the reading by the first set of adders.

In other aspects, the computation of I/FFT is achieved with a Fast Fourier Transform engine (FFTe) configured to receive a multi-point input from the main memory, store the received input in at least one of one or more registers, and compute either or both of a Fast Fourier Transform (FFT) and an Inverse Fast Fourier Transform (IFFT) on the input using a delayless pipeline. The FFTe may be further configured to compute either or both of a Fast Fourier Transform (FFT) and an Inverse Fast Fourier Transform (IFFT) on the input using a gapless pipeline. The FFTe may be further configured to compute either or both of a Fast Fourier Transform (FFT) and an Inverse Fast Fourier Transform (IFFT) using a radix-8 butterfly core. The FFTe may be further configured to compute either or both of a Fast Fourier Transform (FFT) and an Inverse Fast Fourier Transform (IFFT) using a radix-4 butterfly core. The FFTe may be further configured to store the received input in at least 64 registers. The FFTe may be further configured to store the received input from complex multipliers, wherein 56 registers of the at least 64 registers receive input from the complex multipliers. The FFTe may be further configured to store the received input from the main memory in 32 registers of the at least 64 registers. The FFTe may be further configured to receive a z point multi-point input, wherein z is a multiple of 512. The FFTe may be further configured to output the computed transform. The FFTe may be further configured to begin writing the output x cycles after reading the first input, wherein x is 8 plus a pipeline delay. The FFTe may be further configured to complete writing the output y cycles after reading the first input, wherein y is 16 plus a pipeline delay. The FFTe may include a first set of adders configured to read a first set of inputs, and the first inputs are bit-reversed prior to the reading by the first set of adders.

In yet other aspects, the computation of I/FFT is achieved with a method including providing a memory, providing a Fast Fourier Transform engine (FFTe) having one or more registers and a delayless pipeline, configuring the FFTe to receive a multi-point input from the main memory, storing the received input in at least one of the one or more registers, and computing either or both of a Fast Fourier Transform (FFT) and an Inverse Fast Fourier Transform (IFFT) on the input using the delayless pipeline. The FFTe may further include providing a gapless pipeline. The FFTe may include providing a radix-8 butterfly core. The FFTe may include providing a radix-4 butterfly core. The FFTe may include providing at least 64 registers. The FFTe may further include providing complex multipliers, wherein 56 registers of the at least 64 registers receive input from the complex multipliers. The FFTe may include providing 32 registers of the at least 64 registers to receive input from the main memory. The FFTe may be configured to receive a multi-point input comprises configuring the FFTe to receive a z point multi-point input, wherein z is a multiple of 512. The FFTe may be configured to further include outputting the computed transform. The FFTe may include begin writing the output x cycles after reading the first input, wherein x is 8 plus a pipeline delay. The FFTe may include complete writing the output y cycles after reading the first input, wherein y is 16 plus a pipeline delay. The FFTe may further include a first set of adders configured to read a first set of inputs, and the first inputs are bit-reversed prior to the reading by the first set of adders.

In some aspects, the computation of I/FFT is achieved with a processing system having means for storing a first data, one or more means for storing a second data faster than the means for storing the first data, means for receiving a multi-point input from the means for storing the first data, means for storing the received input in at least one of the one or more means for storing a second data, and means for computing either or both of a Fast Fourier Transform (FFT) and an Inverse Fast Fourier Transform (IFFT) on the input using a delayless pipeline. The processing system may further include means for computing either or both of a Fast Fourier Transform (FFT) and an Inverse Fast Fourier Transform (IFFT) on the input using a gapless pipeline. The processing system may further include means for processing the data using a radix-8 butterfly core. The processing system may further include means for processing the data using a radix-4 butterfly core. The processing system may further include means for storing the received input in at least 64 of the means for storing a second data. The processing system may further include means for computing complex multipliers, wherein 56 of the at least 64 the means for storing a second data receives input from the means for computing complex multipliers. The processing system may further include means for receiving input from the means for storing a first data wherein 32 of the means for storing the received input in at least one of the one or more means for storing a second data. The processing system may further include means for receiving a 512-point input from the means for storing the first data. The processing system may further include means for outputting the computed transform. The processing system masy further include means for computing either or both of a Fast Fourier Transform (FFT) and an Inverse Fast Fourier Transform (IFFT) on the input using a delayless pipeline, the FFTe is configured to begin writing the output x cycles after reading the first input, wherein x is 8 plus a pipeline delay. The processing system may further include means for computing either or both of a Fast Fourier Transform (FFT) and an Inverse Fast Fourier Transform (IFFT) on the input using a delayless pipeline, the FFTe is configured to complete writing the output y cycles after reading the first input, wherein y is 16 plus a pipeline delay. The processing system may further include means for computing either or both of a Fast Fourier Transform (FFT) and an Inverse Fast Fourier Transform (IFFT) on the input using a delayless pipeline, the FFTe is configured to include a first set of adders, the first set of adders configured to read a first set of inputs, and the first inputs are bit-reversed prior to the reading by the first set of adders.

In yet other aspects, the computation of I/FFT is achieved with a computer readable media containing a set of instructions for a I/FFT processor to perform a method of computing an I/FFT, the instructions including a routine to receive a multi-point input from the main memory, a routine to store the received input in at least one of one or more registers, and a routine to compute either or both of a Fast Fourier Transform (FFT) and an Inverse Fast Fourier Transform (IFFT) on the input using a delayless pipeline. The FFTe may be further configured to compute either or both of a Fast Fourier Transform (FFT) and an Inverse Fast Fourier Transform (IFFT) on the input using a gapless pipeline. The FFTe may be further configured to compute either or both of a Fast Fourier Transform (FFT) and an Inverse Fast Fourier Transform (IFFT) using a radix-8 butterfly core. The FFTe may be further configured to compute either or both of a Fast Fourier Transform (FFT) and an Inverse Fast Fourier Transform (IFFT) using a radix-4 butterfly core. The FFTe may be further configured to store the received input in at least 64 registers. The FFTe may be further configured to store the received input from complex multipliers, wherein 56 registers of the at least 64 registers receive input from the complex multipliers. The FFTe may be further configured to store the received input from the main memory in 32 registers of the at least 64 registers. The FFTe may be further configured to receive a z point multi-point input, wherein z is a multiple of 512. The FFTe may be further configured to output the computed transform. The FFTe may be further configured to begin writing the output x cycles after reading the first input, wherein x is 8 plus a pipeline delay. The FFTe may be further configured to complete writing the output y cycles after reading the first input, wherein y is 16 plus a pipeline delay. The FFTe may include a first set of adders configured to read a first set of inputs, and the first inputs are bit-reversed prior to the reading by the first set of adders.

Various aspects and embodiments of the invention are described in further detail below.

### BRIEF DESCRIPTION OF THE DRAWINGS

FIG. 1 is a block diagram of a wireless communication system;

FIG. 2 is a block diagram of an OFDM receiver;

FIG. 3 is a block diagram of an FFT processor;

FIG. 4 is a block diagram of the FFT processor in relation to other signal processing blocks;

FIG. 5 is a block diagram of an FFT module 500;

FIG. 6 is a block diagram of a radix-8 FFT module 600;

FIG. 7 is a block diagram of the registers module in the radix-8 FFT module;

FIG. 8 are diagrams of a transpose memory multiplication order for a 512 point radix-8 FFT;

FIG. 9 is a diagram of a radix-8 FFT computation timeline; and

FIG. 10 is a block diagram of an I/FFT engine.

### DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs.

The FFT techniques described herein may be used for various applications such as communication systems, signal filters and amplifications, signal processing, optics processing, seismic reflection, image processing, and so on. The FFT techniques described herein may also be used for wireless communication systems such as cellular systems, broadcast systems, wireless local area network (WLAN) systems, and so on. The cellular systems may be Code Division Multiple Access (CDMA) systems, Time Division Multiple Access (TDMA) systems, Frequency Division Multiple Access (FDMA) systems, Orthogonal Frequency Division Multiple Access (OFDMA) systems, Single-Carrier FDMA (SC-FDMA) systems, and so on. The broadcast systems may be MediaFLO systems, Digital Video Broadcasting for Handhelds (DVB-H) systems, Integrated Services Digital Broadcasting for Terrestrial Television Broadcasting (ISDB-T) systems, and so on. The WLAN systems may be IEEE 802.11 systems, Wi-Fi systems, WiMax systems, and so on. These various systems are known in the art.

The FFT techniques described herein may be used for systems with a single subcarrier as well as systems with multiple subcarriers. Multiple subcarriers may be obtained with OFDM, SC-FDMA, or some other modulation technique. OFDM and SC-FDMA partition a frequency band (e.g., the system bandwidth) into multiple orthogonal subcarriers, which are also called tones, bins, and so on. Each subcarrier may be modulated with data. In general, modulation symbols are sent on the subcarriers in the frequency domain with OFDM and in the time domain with SC-FDMA. OFDM is used in various systems such as MediaFLO, DVB-H and ISDB-T broadcast systems, IEEE 802.11a/g WLAN systems, and some cellular systems. Certain aspects and embodiments of the AGC techniques are described below for a broadcast system that uses OFDM, e.g., a MediaFLO system.

Block diagrams described herein may be implemented using any known methods for implementing computational logic. Examples of methods for implementing computational logic include field-programmable gate array (FPGA), application-specific integrated circuit (ASIC), complex programmable logic devices (CPLD), integrated optical circuits (IOC), microprocessors, and so on.

A hardware architecture suitable for an FFT or Inverse FFT (IFFT), a device incorporating an FFT module, and a method of performing an FFT or IFFT are disclosed. The FFT architecture can be generalized to allow for the implementation of an FFT of 8ⁿ points (n is natural number) through the use of a radix-8 FFT module. For example, the FFT architecture can be generalized to allow for the implementation of a 512-point FFT (8³). The FFT architecture allows the number of cycles used to perform the radix-8 FFT to be minimized while maintaining a small chip area. In particular, the FFT architecture configures memory and register space to optimize the number of memory accesses performed during an in place FFT.

The generalization of this FFT architecture, also within the scope of this disclosure, can incorporate other stage orders and combinations. For example, some embodiments of the FFT architecture can deliver a radix-4 FFT, by passing the third stage of I/FFT processing. This allows the FFTe to perform 2048 point FFT's (8×8×8×4). In yet other embodiments, the FFTI architecture can also deliver radix-2 results by passing the second and third stages of I/FFT processing. In cases where less than radix-8 results are used and a subsequent FFT operation will be performed, the twiddle coefficients would incorporate different combinations. For example, one combination to produce a 2048 point FFT is a radix-8 followed by a radix-8, followed by another radix-8, and followed by a radix-4. If the operations were done in a different order, for example, radix-8 then radix-8 then radix-4 then radix-8, a 2048 point FFT would again result but the twiddle coefficients would be different for the radix-4 and radix 8 operations in the third and fourth stages of operation.

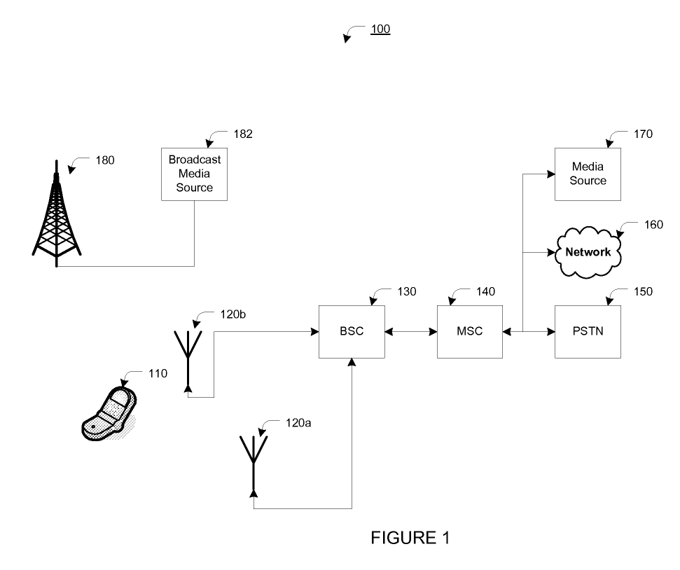

FIG. 1 is a simplified functional block diagram of some embodiments of a wireless communication system 100 and illustrating some embodiments of the FFT pipeline. The system includes one or more fixed elements that can be in communication with a user terminal 110. The user terminal 110 can be, for example, a wireless telephone configured to operate according to one or more communication standards. For example, the user terminal 110 can be configured to receive wireless telephone signals from a first communication network and can be configured to receive data and information from a second communication network.

The user terminal 110 can be a portable unit, a mobile unit, or, a stationary unit. The user terminal 110 may also be referred to as a mobile unit, a mobile terminal, a mobile station, user equipment, a portable, a phone, and the like. Although only a single user terminal 110 is shown in FIG. 1, it is understood that a typical wireless communication system 100 has the ability to communicate with multiple user terminals 110.

The user terminal 110 typically communicates with one or more base stations 120a or 120b, here depicted as sectored cellular towers. The user terminal 110 will typically communicate with the base station, for example 120b, that provides the strongest signal strength at a receiver within the user terminal 110.

Each of the base stations 120a and 120b can be coupled to a Base Station Controller (BSC) 130 that routes the communication signals to and from the appropriate base stations 120a and 120b. The BSC 130 is coupled to a Mobile Switching Center (MSC) 140 that can be configured to operate as an interface between the user terminal 110 and a Public Switched Telephone Network (PSTN) 150. The MSC 140 can also be configured to operate as an interface between the user terminal 110 and a network 160. The network 160 can be, for example, a Local Area Network (LAN) or a Wide Area Network (WAN). In some embodiments, the network 160 includes the Internet. Therefore, the MSC 140 is coupled to the PSTN 150 and network 160. The MSC 140 can also be coupled to one or more media source 170. The media source 170 can be, for example, a library of media offered by a system provider that can be accessed by the user terminal 110. For example, the system provider may provide video or some other form of media that can be accessed on demand by the user terminal 110. The MSC 140 can also be configured to coordinate inter-system handoffs with other communication systems (not shown).

The wireless communication system 100 can also include a broadcast transmitter 180 that is configured to transmit a signal to the user terminal 110. In some embodiments, the broadcast transmitter 180 can be associated with the base stations 120a and 120b. In other embodiments, the broadcast transmitter 180 can be distinct from, and independent of, the wireless telephone system containing the base stations 120a and 120b. The broadcast transmitter 180 can be, but is not limited to, an audio transmitter, a video transmitter, a radio transmitter, a television transmitter, and the like or some combination of transmitters. Although only one broadcast transmitter 180 is shown in the wireless communication system 100, the wireless communication system 100 can be configured to support multiple broadcast transmitters 180.

A plurality of broadcast transmitters 180 can transmit signals in overlapping coverage areas. A user terminal 110 can concurrently receive signals from a plurality of broadcast transmitters 180. The plurality of broadcast transmitters 180 can be configured to broadcast identical, distinct, or similar broadcast signals. For example, a second broadcast transmitter having a coverage area that overlaps the coverage area of the first broadcast transmitter may also broadcast a subset of the information broadcast by a first broadcast transmitter.

The broadcast transmitter 180 can be configured to receive data from a broadcast media source 182 and can be configured to encode the data, modulate a signal based on the encoded data, and broadcast the modulated data to a service area where it can be received by the user terminal 110.

In some embodiments, one or both of the base stations 120a and 120b and the broadcast transmitter 180 transmits an Orthogonal Frequency Division Multiplex (OFDM) signal. The OFDM signals can include a plurality of OFDM symbols modulated to one or more carriers at predetermined operating bands.

An OFDM communication system utilizes OFDM for data and pilot transmission. OFDM is a multi-carrier modulation technique that partitions the overall system bandwidth into multiple (K) orthogonal frequency subbands. These subbands are also called tones, carriers, subcarriers, bins, and frequency channels. With OFDM, each subband is associated with a respective subcarrier that may be modulated with data.

A transmitter in the OFDM system, such as the broadcast transmitter 180, may transmit multiple data streams simultaneously to wireless devices. These data streams may be continuous or bursty in nature, may have fixed or variable data rates, and may use the same or different coding and modulation schemes. The transmitter may also transmit a pilot to assist the wireless devices perform a number of functions such as time synchronization, frequency tracking, channel estimation, and so on. A pilot is a transmission that is known a priori by both a transmitter and a receiver.

The broadcast transmitter 180 can transmit OFDM symbols according to an interlace subband structure. The OFDM interlace structure includes K total subbands, where K>1. U subbands may be used for data and pilot transmission and are called usable subbands, where U≦K. The remaining G subbands are not used and are called guard subbands, where G=K−U. As an example, the system may utilize an OFDM structure with K=4096 total subbands, U=4000 usable subbands, and G=96 guard subbands. For simplicity, the following description assumes that all K total subbands are usable and are assigned indices of 0 through K−1, so that U=K and G=0.

The K total subbands may be arranged into M interlaces or non-overlapping subband sets. The M interlaces are non-overlapping or disjoint in that each of the K total subbands belongs to one interlace. Each interlace contains P subbands, where P=K/M. The P subbands in each interlace may be uniformly distributed across the K total subbands such that consecutive subbands in the interlace are spaced apart by M subbands. For example, interlace 0 may contain subbands 0, M, 2M, and so on, interlace 1 may contain subbands 1, M+1, 2M+1, and so on, and interlace M−1 may contain subbands M−1, 2M−1, 3M−1, and so on. For the exemplary OFDM structure described above with K=4096, M=8 interlaces may be formed, and each interlace may contain P=512 subbands that are evenly spaced apart by eight subbands. The P subbands in each interlace are thus interlaced with the P subbands in each of the other M−1 interlaces.

In general, the broadcast transmitter 180 can implement any OFDM structure with any number of total, usable, and guard subbands. Any number of interlaces may also be formed. Each interlace may contain any number of subbands and any one of the K total subbands. The interlaces may contain the same or different numbers of subbands. For simplicity, much of the following description is for an interlace subband structure with M=8 interlaces and each interlace containing P=512 uniformly distributed subbands. This subband structure provides several advantages. First, frequency diversity is achieved since each interlace contains subbands taken from across the entire system bandwidth. Second, a wireless device can recover data or pilot sent on a given interlace by performing a partial P-point fast Fourier transform (FFT) instead of a full K-point FFT, which can simplify the processing at the wireless device.

The broadcast transmitter 180 may transmit a frequency division multiplexed (FDM) pilot on one or more interlaces to allow the wireless devices to perform various functions such as channel estimation, frequency tracking, time tracking, and so on. The pilot is made up modulation symbols that are known a priori by both the base station and the wireless devices, which are also called pilot symbols. The user terminal 110 can estimate the frequency response of a wireless channel based on the received pilot symbols and the known transmitted pilot symbols. The user terminal 110 is able to sample the frequency spectrum of the wireless channel at each subband used for pilot transmission.

The system 100 can define M slots in the OFDM system to facilitate the mapping of data streams to interlaces. Each slot may be viewed as a transmission unit or a mean for sending data or pilot. A slot used for data is called a data slot, and a slot used for pilot is called a pilot slot. The M slots may be assigned indices 0 through M−1. Slot 0 may be used for pilot, and slots 1 through M−1 may be used for data. The data streams may be sent on slots 1 through M−1. The use of slots with fixed indices can simplify the allocation of slots to data streams. Each slot may be mapped to one interlace in one time interval. The M slots may be mapped to different ones of the M interlaces in different time intervals based on any slot-to-interlace mapping scheme that can achieve frequency diversity and good channel estimation and detection performance. In general, a time interval may span one or multiple symbol periods. The following description assumes that a time interval spans one symbol period.

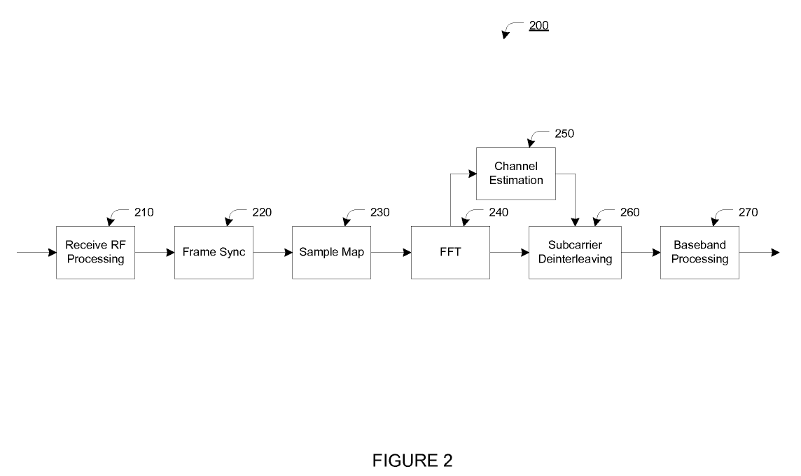

FIG. 2 is a simplified functional block diagram of an OFDM receiver 200 that can be implemented, for example, in the user terminal of FIG. 1. The receiver 200 can be configured to implement a FFT processing block as described herein to perform processing of received OFDM symbols.

The receiver 200 includes a receive RF processor 210 configured to receive the transmitted RF OFDM symbols over an RF channel, process them and frequency convert them to baseband OFDM symbols or substantially baseband signals. A signal can be referred to as substantially a baseband signal if the frequency offset from a baseband signal is a fraction of the signal bandwidth, or if signal is at a sufficiently low intermediate frequency to allow direct processing of the signal without further frequency conversion. The OFDM symbols from the receive RF processor 210 are coupled to a frame synchronizer 220.

The frame synchronizer 220 can be configured to synchronize the receiver 200 with the symbol timing. In some embodiments, the frame synchronizer can be configured to synchronize the receiver to the superframe timing and to the symbol timing within the superframe.

The frame synchronizer 220 can be configured to determine an interlace based on a number of symbols required for a slot to interlace mapping to repeat. In some embodiments, a slot to interlace mapping may repeat after every 14 symbols. The frame synchronizer 220 can determine the modulo-14 symbol index from the symbol count. The receiver 200 can use the modulo-14 symbol index to determine the pilot interlace as well as the one or more interlaces corresponding to assigned data slots.

The frame synchronizer 220 can synchronize the receiver timing based on a number of factors and using any of a number of techniques. For example, the frame synchronizer 220 can demodulate the OFDM symbols and can determine the superframe timing from the demodulated symbols. In other embodiments, the frame synchronizer 220 can determine the superframe timing based on information received within one or more symbols, for example, in an overhead channel. In other embodiments, the frame synchronizer 220 can synchronize the receiver 200 by receiving information over a distinct channel, such as by demodulating an overhead channel that is received distinct from the OFDM symbols. Of course, the frame synchronizer 220 can use any manner of achieving synchronization, and the manner of achieving synchronization does not necessarily limit the manner of determining the modulo symbol count.

The output of the frame synchronizer 220 is coupled to a sample map 230 that can be configured to demodulate the OFDM symbol and map the symbol samples or chips from a serial data path to any one of a plurality of parallel data paths. For example, the sample map 220 can be configured to map each of the OFDM chips to one of a plurality of parallel data paths corresponding to the number of subbands or subcarriers in the OFDM system.

The output of the sample map 230 is coupled to an FFT module 240 that is configured to transform the OFDM symbols to the corresponding frequency domain subbands. The FFT module 240 can be configured to determine the interlace corresponding to the pilot slot based on the modulo-14 symbol count. The FFT module 240 can be configured to couple one or more subbands, such as predetermined pilot subbands, to a channel estimator 250. The pilot subbands can be, for example, one or more equally spaced sets of OFDM subbands spanning the bandwidth of the OFDM symbol.

The channel estimator 250 is configured to use the pilot subbands to estimate the various channels that have an effect on the received OFDM symbols. In some embodiments, the channel estimator 250 can be configured to determine a channel estimate corresponding to each of the data subbands.

The subbands from the FFT module 240 and the channel estimates are coupled to a subcarrier symbol deinterleaver 260. The symbol deinterleaver 260 can be configured to determine the interlaces based on knowledge of the one or more assigned data slots, and the interleaved subbands corresponding to the assigned data slots.

The symbol deinterleaver 260 can be configured, for example, to demodulate each of the subcarriers corresponding to the assigned data interlace and generate a serial data stream from the demodulated data. In other embodiments, the symbol deinterleaver 260 can be configured to demodulate each of the subcarriers corresponding to the assigned data interlace and generate a parallel data stream. In yet other embodiments, the symbol deinterleaver 260 can be configured to generate a parallel data stream of the data interlaces corresponding to the assigned slots.

The output of the symbol deinterleaver 260 is coupled to a baseband processor 270 configured to further process the received data. For example, the baseband processor 270 can be configured to process the received data into a multimedia data stream having audio and video. The baseband processor 270 can send the processed signals to one or more output devices (not shown).

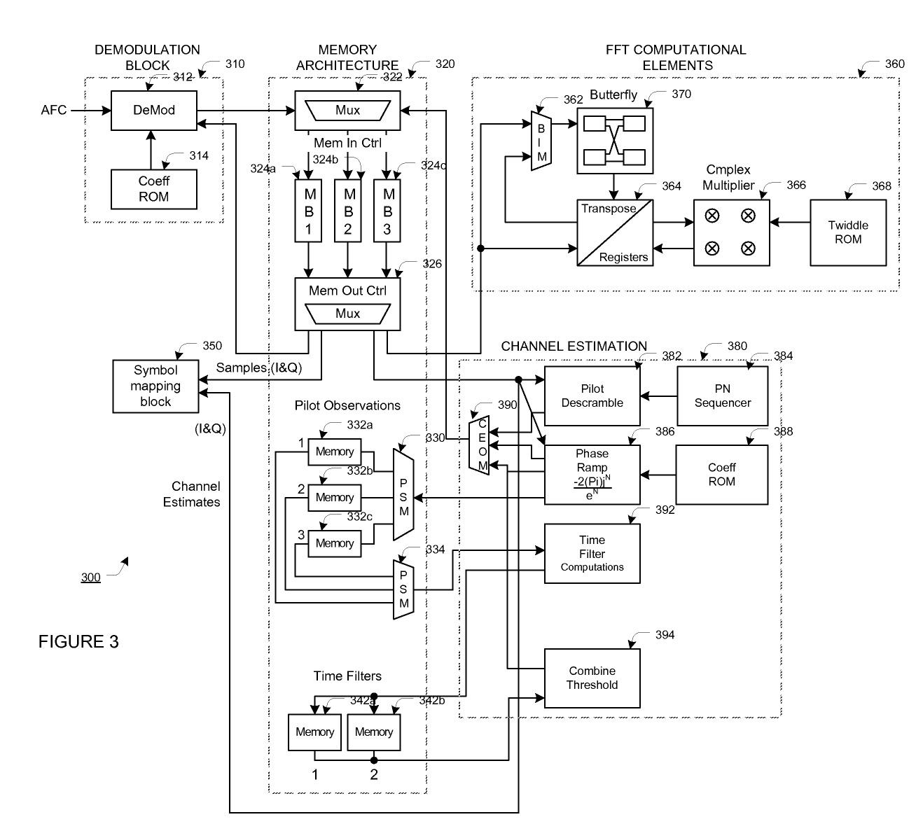

FIG. 3 is a simplified functional block diagram of some embodiments of an FFT processor 300 for a receiver operating in an OFDM system. The FFT processor 300 can be used, for example, in the wireless communication system of FIG. 1 or in the receiver of FIG. 2. In some embodiments, the FFT processor 300 can be configured to perform portions or all of the functions of the frame synchronizer, FFT module, and channel estimator of the receiver embodiment of FIG. 2.

The FFT processor 300 can be implemented in an Integrated Circuit (IC) on a single IC substrate to provide a single chip solution for the processing portion of OFDM receiver designs. Alternatively, the FFT processor 300 can be implemented on a plurality of ICs or substrates and packaged as one or more chips or modules. For example, the FFT processor 300 can have processing portions performed on a first IC and the processing portions can interface with memory that is on one or more storage devices distinct from the first IC.

The FFT processor 300 includes a demodulation block 310 coupled to a memory architecture 320 that interconnects an FFT computational block 360 and a channel estimator 380. A symbol mapping block 350, where symbols are mapped, may optionally be included as part of the FFT processor 300, or may be implemented within a distinct block that may or may not be implemented on the same substrate or ICs as the FFT processor 300. In the symbol mapping block 350, symbol deinterleaving also occurs. One illustrative example of a symbol mapping block is a log likelihood ratio.

The demodulation, FFT, channel estimate and Symbol Mapping modules perform operations on sample values. The memory architecture 320 allows for any of these modules to access any block at a given time. The switching logic is simplified by temporally dividing the memory banks.

One bank of memory is used repeatedly by the demodulation block 310. The FFT computational block 320 accesses the bank actively being processed. The channel estimate block 380 accesses the pilot information of the bank currently being processed. The symbol mapping block 350 accesses the bank containing the oldest samples.

The demodulation block 310 includes a demodulator 312 coupled to a coefficient ROM 314. The demodulation block 310 processes the time synchronized OFDM symbols to recover the pilot and data interlaces. In the example described above, OFDM symbol includes 4096 subbands divided into 8 distinct interlaces, where each interlace has subbands uniformly spaced across the entire 4096 subbands.

The demodulator 312 organizes the incoming 4096 samples into the eight interlaces. The demodulator rotates each incoming sample by w(n)=e₋ⱼ2πn/512, with n representing interlaces 0 through 7. The first 512 values are rotated and stored in each interlace. For each set of 512 samples that follow, the demodulator 312 rotates and then adds the values. Each memory location in each interlace will have accumulated eight rotated samples. Values in interlace 0 are not rotated, just accumulated. The demodulator 312 can represent the rotated and accumulated values in a larger number of bits than are used to represent the input samples to accommodate growth due to accumulation and rotation.

The coefficient ROM 314 is used to store the complex rotation coefficients. Seven coefficients are required for each incoming sample, as interlace 0 does not require any rotation. The coefficient ROM 314 can be rising-edge triggered, which can result in a 1-cycle delay from when the demodulation block 310 receives the sample.

The demodulation block 310 can be configured to register each coefficient value retrieved from coefficient ROM 314. The act of registering the coefficient value adds another cycle delay before the coefficient values themselves can be used.

For each incoming sample, seven different coefficients are used, each with a different address. Seven counters are used to look up the different coefficients. Each counter is incremented by its interlace number; for every new sample, for example, interlace 1 increments by 1, while interlace 7 increments by 7. It is typically not practical to create a ROM image to hold all of the seven coefficients required in a single row or to use seven different ROMs. Therefore, the demodulation pipeline starts by fetching coefficient values when a new sample arrives.

To reduce the size of the coefficient memory, the COS and SIN values between 0 and π/4 are stored. The three most-significant bits (MSBs) of the coefficient address that are not sent to the memory can be used to direct the values to the appropriate quadrants. Thus, values read from the coefficient ROM 314 are not registered immediately.

The memory architecture 320 includes an input multiplexer 322 coupled to multiple memory banks 324a-324c. The memory banks 324a-324c are coupled to a memory control block 326 that includes a multiplexer capable of routing values from each of the memory banks 324a-324c to a variety of modules.

The memory architecture 320 also includes memory and control for pilot observation processing. The memory architecture 320 includes an input pilot selection multiplexer 330 coupling pilot observations to any one of a plurality of pilot observation memory 332a-332c. The plurality of pilot observation memory 332a-332c is coupled to an output pilot selection multiplexer 334 to allow contents of any of the memory to be selected for processing. The memory architecture 320 can also include a plurality of memory portions 342a-342b to store processed channel estimates determined from the pilot observations.

The orthogonal frequencies used to generate an OFDM symbol can conveniently be processed using a Fourier Transform, such as an FFT. An FFT computational block 360 can include a number of elements configured to perform efficient FFT and Inverse-FFT (IFFT) operations of one or more predetermined dimensions. Typically the dimensions are powers of two, but FFT or IFFT operations are not limited to dimensions that are powers of two.

The FFT computational block 360 includes a butterfly core 370 that can operate on complex data retrieved from the memory architecture 320 or transpose registers 364. The FFT computational block 360 includes a butterfly input multiplexer 362 that is configured to select between the memory architecture 320 and the transpose registers 354. The butterfly core 370 operates in conjunction with a complex multiplier 366 and twiddle memory 368 to perform the butterfly operations.

The channel estimator 380 can include a pilot descrambler 382 operating in conjunction with PN sequencer 384 to descramble pilot samples. A phase ramp module 386 operates to rotate pilot observations from a pilot interlace to any of the various data interlaces. Phase ramp coefficient memory 388 is used to store the phase ramp information needed to rotate the samples amongst the possible interlaces.

A time filter 392 can be configured to time filter multiple pilot observations over multiple symbols. The filtered outputs from the time filter 392 can be stored in the memory architecture 320 and further processed by a thresholder 394 prior to being returned to the memory architecture 320 for use in the symbol mapping block 350 that performs the decoding of the underlying subband data.

The channel estimator 380 can include a channel estimation output multiplexer 390 to interface various channel estimator output values, including intermediate and final output values, to the memory architecture 320.

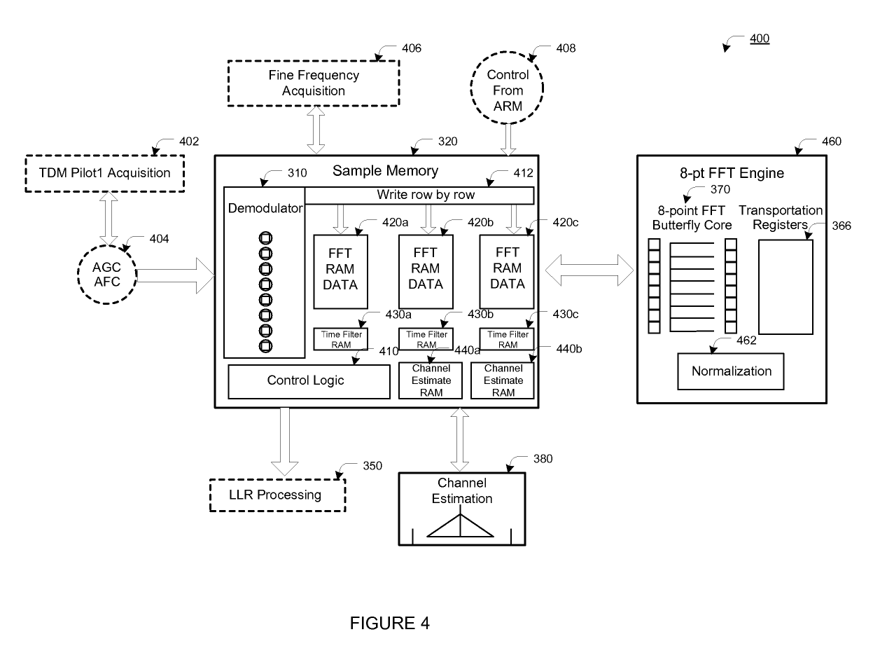

FIG. 4 is a simplified functional block diagram of some embodiments of an FFT processor 400 in relation to other signal processing blocks in an OFDM receiver. The TDM pilot acquisition module 402 generates an initial symbol synchronization and timing for the FFT processor 400. Incoming in-phase (I) and quadrature (Q) samples are coupled to the AGC module 404 that operates to implement gain and frequency control loops that maintain the signal within a desired amplitude and frequency error. In some embodiments, a frame synchronizer can be used instead of the term TDM pilot acquisition module. The AFC function is performed in the Frame synchronizer block, while the AGC function can be performed before the Frame synchronizer (Receive RF processing from FIG. 2).

A control processor 408 performs high level control of the FFT processor 400. The control processor 408 can be, for example, a general purpose processor or a Reduced Instruction Set Computer (RISC) processor, such as those designed by ARM™. The control processor 408 can, for example, control the operation of the FFT processor 408 by controlling the symbol synchronization, selectively controlling the state of the FFT processor 400 to active or sleep states, or otherwise controlling the operation of the FFT processor 400.

Control logic 410 within the FFT processor 400 can be used to interface the various internal modules of the FFT processor 400. The control logic 410 can also include logic for interfacing with the other modules external to the FFT processor 400.

The I and Q samples are coupled to the FFT processor 400, and more particularly, to the demodulation block 310 of the FFT processor 400. The demodulation block 310 operates to separate the samples to the predetermined number of interlaces. The demodulation block 310 interfaces with the memory architecture 320 to store the samples for processing and delivery to a symbol mapping block 350 for decoding of the underlying data.

The memory architecture 320 can include a memory controller 412 for controlling the access of the various memory banks within the memory architecture 320. For example, the memory controller 412 can be configured to allow row writes to locations within the various memory banks.

The memory architecture 320 can include a plurality of FFT RAM 420a-420c for storing the FFT data. Additionally, a plurality of time filter memory 430a-430c can be used to store time filter data, such as pilot observations used to generate channel estimates.

Separate channel estimate memory 440a-440b can be used to store intermediate channel estimate results from the channel estimator 380. The channel estimator 380 can use the channel estimate memory 440a-440b when determining the channel estimates.

The FFT processor 400 includes an FFT computational block that is used to perform at least portions of the FFT operation. In the embodiments of FIG. 4, the FFT computational block is an 8-point FFT engine 460. An 8-point FFT engine 460 can be advantageous for processing the illustrative example of the OFDM symbol structure described above. As described earlier, each OFDM symbol includes 4096 subbands divided into 8 interlaces of 512 subbands each. The number of subbands in each interlace, 512, is the cube of 8 (83=512). Thus, a 512-point FFT can be performed in three stages using a radix-8 FFT. In fact, because 4096 is the fourth power of 8, a 4096-point FFT can be performed with just one additional FFT stage, for a total of four stages.

The 8-point FFT engine 460 can include a butterfly core 370 and transpose registers 364 adapted to perform a radix-8 FFT. A normalization block 462 is used to normalize the products generated by the butterfly core 370. The normalization block 462 can operate to limit the bit growth of the memory locations needed to represent the values output from the butterfly core following each stage of the FFT.

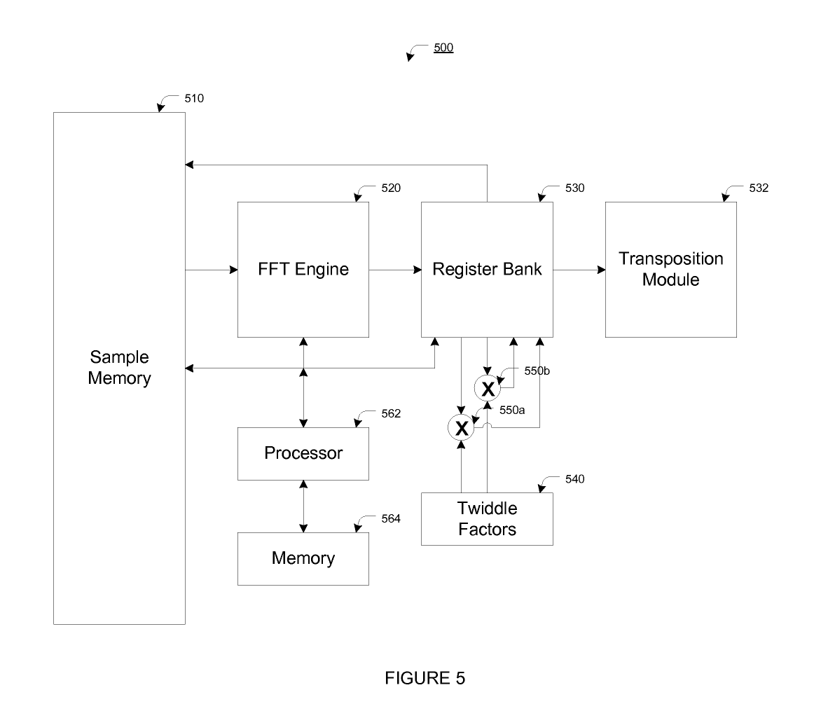

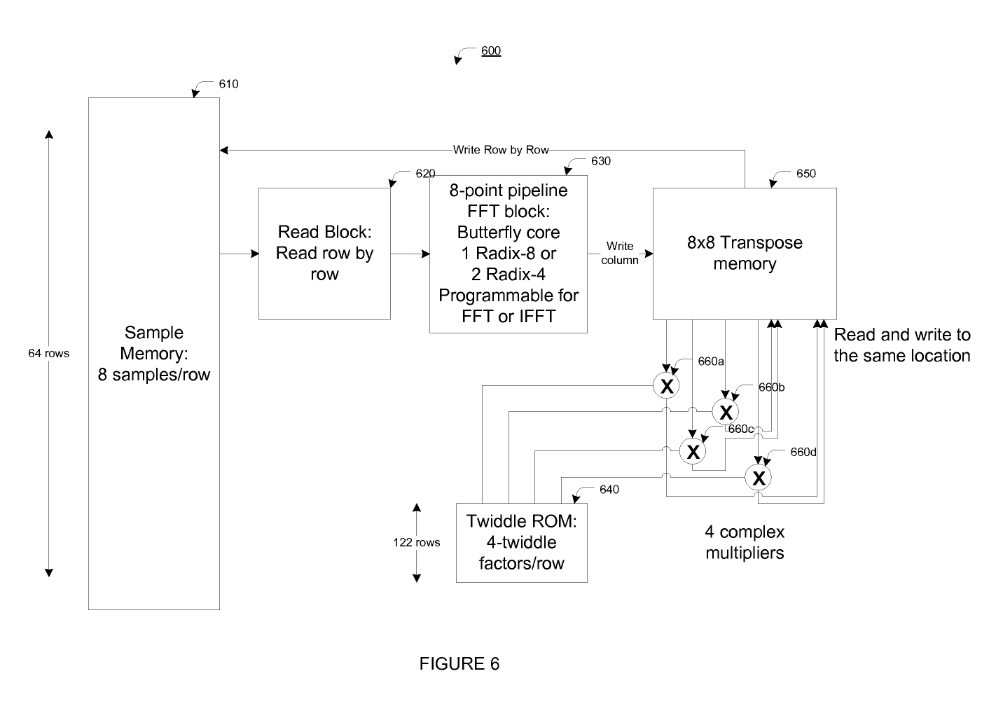

FIG. 5 is a functional block diagram of some embodiments of an FFT module 500. The FFT module 500 may be configured as an I/FFT module with small changes, due to the symmetry between the forward and inverse transforms. The FFT module 500 may be implemented on a single IC die, as part of an ASIC, as a FPGA, or as any approach to logic implementations. Alternatively, the FFT module 500 may be implemented as multiple elements that are in communication with one another. Additionally, the FFT module 500 is not limited to a particular FFT structure. For example, the FFT module 500 can be configured to perform a decimation in time or a decimation in frequency FFT (further detailed in Equation 1 below). FIG. 5 describes the general scenario of a radix r FFT and FIG. 6 describes the specific scenario of radix 8 FFT.

Referring back to FIG. 5, the FFT module 500 includes a memory 510 that is configured to store the samples to be transformed. Additionally, because the FFT module 500 is configured to perform an in-place computation of the transform, the memory 510 is used to store the results of each stage of the FFT and the output of the FFT module 500.

The memory 510 can be sized based in part on the size of the FFT and the radix of the FFT. For an N point FFT of radix r, where N=rⁿ, the memory 510 can be sized to store the N samples in rⁿ−1 rows, with r samples per row. The memory 510 can be configured to have a width that is equal to the number of bits per sample multiplied by the number of samples per row. The memory 510 is typically configured to store samples as real and imaginary components. Thus, for a radix 2 FFT, the memory 510 is configured to store two samples per row, and may store the samples as the real part of the first sample, the imaginary part of the first sample, the real part of the second sample, and the imaginary part of the second sample. If each component of a sample is configured as 10 bits, the memory 510 uses 40 bits per row. The memory 510 can be Random Access Memory (RAM) of sufficient speed to support the operation of the module.

The memory 510 is coupled to an FFT engine 520 that is configured to perform an r-point FFT. The FFT module 500 can be configured to perform an FFT where the weighting by the twiddle factors is performed after the partial FFT, also referred to as an FFT butterfly. Such a configuration allows the FFT engine 520 to be configured using a minimal number of multipliers, thus minimizing the size and complexity of the FFT engine 520. The FFT engine 520 can be configured to retrieve a row from the memory 510 and perform an FFT on the samples in the row. Thus, the FFT engine 520 can retrieve all of the samples for an r-point FFT in a single cycle. The FFT engine 520 can be, for example, a pipelined FFT engine and may be capable of manipulating the values in the rows on different phases of a clock.

The output of the FFT engine 520 is coupled to a register bank 530. The register bank 530 is configured to store a number of values based on the radix of the FFT. In some embodiments, the register bank 530 can be configured to store r² values. As was the case with the samples, the values stored in the register bank are typically complex values having a real and imaginary component.

The register bank 530 is used as temporary storage, but is configured for fast access and provides a dedicated location for storage that does not need to be accessed through an address bus. For example, each bit of a register in the register bank 530 can be implemented with a flip-flop. As a consequence, a register uses much more die area compared to a memory location of comparable size. Because there is effectively no cycle cost to accessing register space, a particular FFT module 500 implementation can trade off speed for die area by manipulating the size of the register bank 530 and memory 510.

The register bank 530 can advantageously be sized to store r² values such that a transposition of the values can be performed directly, for example, by writing values in by rows and reading values out by columns, or vice versa. The value transposition is used to maintain the row alignment of FFT values in the memory 510 for all stages of the FFT.

A second memory 540 is configured to store the twiddle factors that are used to weight the outputs of the FFT engine 520. In some embodiments, the FFT engine 520 can be configured to use the twiddle factors directly during the calculation of the partial FFT outputs (FFT butterflies). The twiddle factors can be predetermined for any FFT. Therefore, the second memory 540 can be implemented as Read Only Memory (ROM), non-volatile memory, non-volatile RAM, or flash programmable memory, although the second memory 540 may also be configured as RAM or some other type of memory. The second memory 540 can be sized to store N×(n−1) complex twiddle factors for an N point FFT, where N=rⁿ. Some of the twiddle factors such as 1, −1, j or −j, may be omitted from the second memory 540. Additionally, duplicates of the same value may also be omitted from the second memory 540. Therefore, the number of twiddle factors in the second memory 540 may be less than N.times.(n−1). An efficient implementation can take advantage of the fact that the twiddle factors for all of the stages of an FFT are subsets of the twiddle factors used in the first stage or the final stage of an FFT, depending on whether the FFT implements a decimation in frequency or decimation in time algorithm.

Complex multipliers 550a-550b are coupled to the register bank and the second memory 540. The complex multipliers 550a-550b are configured to weight the outputs of the FFT engine 520, which are stored in the register bank 530, with the appropriate twiddle factor from the second memory 540. The embodiments shown in FIG. 5 includes two complex multipliers 550a and 550b. However, the number of complex multipliers, for example 250a, that are included in the FFT module 200 can be selected based on a trade off of speed to die area. A greater number of complex multipliers can be implemented on a die in order to speed execution of the FFT. However, the increased speed comes at the cost of die area. Where die area is critical, the number of complex multipliers may be reduced. Typically, a design would not include greater than r−1 complex multipliers when an r point FFT engine 520 is implemented, because r−1 complex multipliers are sufficient to apply all non-trivial twiddle factors to the outputs of the FFT engine 520 in parallel. As an example, an FFT module 500 configured to perform an 8-point radix 2 FFT can implement 2 complex multipliers, but may implement 1 complex multiplier.

Each complex multiplier, for example 550a, operates on a single value from the register bank 530 and corresponding twiddle factor stored in second memory 540 during each multiplication operation. If there are fewer complex multipliers than there are complex multiplications to be performed, a complex multiplier will perform the operation on multiple FFT values from the register bank 530.

The output of the complex multiplier, for example 550a, is written to the register bank 530, typically to the same position that provided the input to the complex multiplier. Therefore, after the complex multiplications, the contents of the register bank represent the FFT stage output that is the same regardless if the complex multipliers were implemented within the FFT engine 520 or associated with the register bank 530 as shown in FIG. 5.

A transposition module 532 coupled to the register bank 530 performs a transposition on the contents of the register bank 530. The transposition module 532 can transpose the register contents by rearranging the register values. Alternatively, the transposition module 532 can transpose the contents of the register block 530 as the contents are read from the register block 530. The contents of the register bank 530 are transposed before being written back into the memory 510 at the rows that supplied the inputs to the FFT engine 520. Transposing the register bank 530 values maintains the row structure for FFT inputs across all stages of the FFT.

A processor 562 in combination with instruction memory 564 can be configured to perform the data flow between modules, and can be configured to perform some or all of one or more of the blocks of FIG. 5. For example, the instruction memory 564 can store one or more processor usable instructions as software that directs the processor 562 to manipulate the data in the FFT module 500.

The processor 562 and instruction memory 564 can be implemented as part of the FFT module 500 or may be external to the FFT module 500. Alternatively, the processor 562 may be external to the FFT module 500 but the instruction memory 564 can be internal to the FFT module 500 and can be, for example, common with the memory 510 used for the samples, or the second memory 540 in which the twiddle factors are stored.

The embodiments shown in FIG. 5 features a tradeoff between speed and area as the radix of the algorithm changes. For implementing a N=r^{v} point FFT, the number of cycles required can be estimated as:

$${N}_{cycles} \approx ( \frac{N}{{r}^{2}} \cdot v ) \cdot r \cdot {N}_{FFT}$$

$$where , \\ \frac{N}{{r}^{2}} \cdot v = Number of r ,$$

radix-r FFTs to be computed

rN_{FFT}=r×Time taken to perform one read, FFT, twiddle multiply and write for a vector of r elements.

N_{FFT} is assumed to be constant independent of the radix. The cycle count decreases on the order of 1/r (O(1/r)). The area required for implementation increases O(r²) as the number of registers required for transposition increase as r². The number of registers and the area required to implement registers dominates the area for large N.

The minimum radix that provides the desired speed can be chosen to implement the FFT for different cases of interest. Minimizing the radix, provided the speed of the module is sufficient, minimizes the die area used to implement the module.

In some embodiments, a 512-point FFT is implemented using the Decimation in Frequency approach (see Equation 1). This approach cascades three radix-8 FFTs to achieve a 512-point FFT.

$$X [ 64 {a}_{1} + 8 {a}_{2} + {a}_{3} ] = \frac{1}{{2}^{5}} ( {\sum }_{{b}_{1} = 0}^{7} ( {\sum }_{{b}_{2} = 0}^{7} ( {\sum }_{{b}_{3} = 0}^{7} x ( {b}_{1} + 8 {b}_{2} + 64 {b}_{3} ) \cdot {W}_{8}^{{b}_{1} {a}_{1}} ) \cdot {W}_{512}^{( 8 {b}_{2} + {b}_{1} ) {a}_{3}} \cdot {W}_{8}^{{b}_{2} {a}_{2}} ) \cdot {W}_{64}^{{b}_{1} {a}_{2}} \cdot {W}_{8}^{{b}_{1} {a}_{1}} ) \qquad Equation 1$$

where a₁, a₂, a₃, b₁, b₂, b_{3 ε {0 . . . 7}}

2^{S}=Scale Factor of FFT

The difference between decimation in frequency and decimation in time is the twiddle memory coefficients. Since we are implementing the 512-point FFT operation using radix-8 FFT units, there are three stages of processing.

FIG. 6 is a functional block diagram of some embodiments of a radix-8 FFT module 600. Similar to the generic FFT module 500 in FIG. 5, the radix-8 FFT module 600 may be configured as an IFFT module with few changes, due to the symmetry between the forward and inverse transforms. The FFT module 600 may be implemented on a single IC die, as part of an ASIC, as a FPGA, or as any approach to logic implementations. Alternatively, the FFT module 600 may be implemented as multiple elements that are in communication with one another. Additionally, the radix-8 FFT module 600 is not limited to a particular FFT structure.

The radix-8 FFT architecture 600 includes a sample memory 610 that is configured to have a memory row width that is sufficient to store 8 samples per row. Thus, the sample memory is configured to have 64 rows of 8 samples per row. An FFT read block 620 is configured to retrieve rows from the memory and performs an 8-point FFT on the samples in each row.

The radix-8 FFT module 600 may include a separate processor memory (not shown) that is configured to store the samples to be transformed. Additionally, the radix-8 FFT module 600 may include a separate processor (not shown) for implementing the sample transforms. Because the FFT module 600 is configured to perform an in-place computation of the transform, the memory is used to store the results of each stage of the FFT and the output of the FFT module 600.

The read block 620 is coupled to an 8-point pipeline FFT block 630 that is configured to perform an 8-point FFT computation. In some embodiments, the 8-point pipeline FFT block 630 is a butterfly core computing one radix-8. Further, the 8-point pipeline FFT block 630 may be programmable for FFT or IFFT computation. The values read from memories 610 are immediately registered.

Output values from the 8-point pipeline FFT block 630 are written column by column into an 8×8 transpose memory 650. The transpose memory 650 is further coupled to four complex multipliers 660a 660b 660c 660d (660, collectively) and a twiddle ROM 640. The complex multipliers 660 read the twiddle coefficients from the transpose memory 650, execute the computation based on instructions from the twiddle ROM 640, and writes the outputs back to the transpose memory 650. The outputs are written to same location as the inputs (i.e. replace the input data) allowing the transpose memory to maintain a constant memory footprint. The instructions for the order and the location of the reads and the writes as executed by the complex multipliers 660 are stored in the twiddle ROM 640. The twiddle ROM 640 contains 122 rows of 4 twiddle factors per row. The output from the transpose memory 650 is also written row by row back to the sample memory 610.

The 8×8 transpose memory can be implemented in any writable data store. Examples of memory modules include integrated circuits such as RAM, registers, Flash, magnetic disks, optical disks, and so on. In some preferred embodiments, RAM is used based on the cost/performance tradeoffs compared to other data stores.

The FFT block uses three passes through the radix-8 butterfly core to perform a single 512 point FFT. The results from the first two passes have some of their values multiplied by twiddle values and normalized. Because eight values are stored in a single row of memory, the ordering of the values as they are read is different than when values are written back. If a 2k I/FFT is performed, memory values is transposed before being sent to the butterfly core.

The radix-8 FFT requires 8×8 registers. All 64 registers receive input from the butterfly core. Of these registers, 56 registers receive input from the complex multipliers and 32 registers receive input from main memory. Inputs from main memory are written to a row of registers. Inputs from the butterfly core are written to columns of registers. Inputs from the complex multipliers are performed in groups.

All 64 registers send output to main memory through a normalization computation and register. The order of normalization is different for each type and stage of the I/FFT. Specifically, 56 registers require twiddle multiplication. 32 registers have their values sent to the butterfly core. When values are sent to the butterfly core, they are sent column by column. When values are sent to the complex multipliers, they are done in groups.

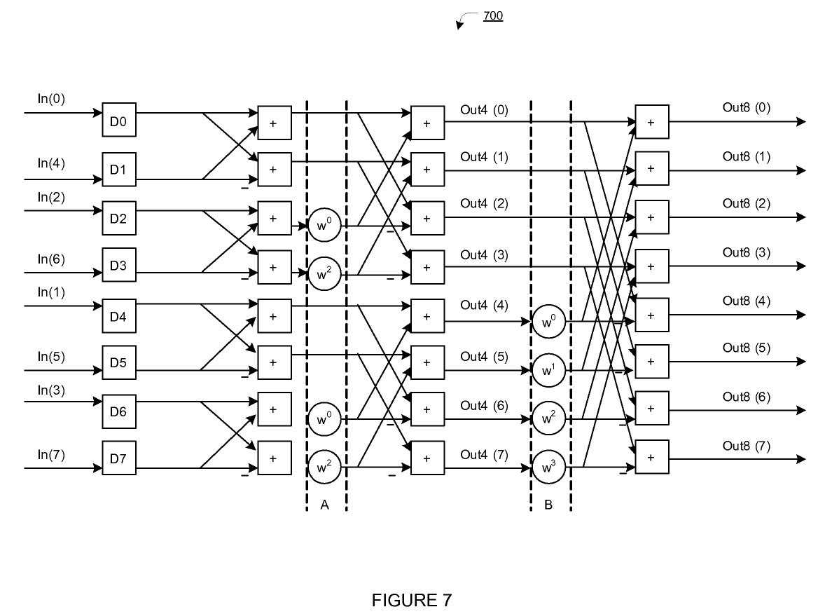

FIG. 7 is a functional block diagram of some embodiments of the butterfly core 700 that are used when the core is operated in radix-8 mode for a 512 point FFT. The signal flow of the FFT butterfly calculations and twiddle multiplications are shown. The 512-point FFT uses a sample memory 610 of 64 rows (one for each of the eight 8-point FFTs) and 8 columns (8 samples/row). The register block is configured as an 8×8 matrix (the transpose memory 650). There are 2 ‘twiddle’ multiplications that occur during FFT processing. The twiddle multiplication in FIG. 7 refers to the multiplications associated with a single pass through the I/FFT butterfly.

The initial contents of the sample memory 610 are arranged in eight rows of eight columns each. Rows are retrieved from sample memory and FFTs performed on the values stored in the rows. The results are weighted with appropriate twiddle factors, and the results written into the register bank. The register bank values are then transposed before being written back to sample memory. Previous register values are over written making the order the calculations are executed important. However, this approach to using the same registers and careful ordering allows for faster computation of the FFT and a small memory requirement. This is further described in FIGS. 8a and 8b.

Referring back to FIG. 7, in executing the radix-8 FFT in the core 700, first, the inputs are read, bit-reversed prior to the first set of adders, and stored in the registers. For radix-8 operation, the bit reversal is the full 3-bit reversal: 0→0, 1→4, 2→2, 3→6, 4→1, 5→5, 6→3, 7→7.

Next, the values are each added as shown in FIG. 7. For example, D0 is added to D1 to produce the input to Out4(0). Generally,

$${w}^{k} = {ⅇ}^{\frac{- j2π k}{8}} .$$

w⁰ through w³ are used for FFT operations. w⁰ and w⁵ through w⁷ are used of IFFT operations. Specifically, the w* substitution is detailed in Table 1.

TABLE 1

| FFT | IFFT |
|---|---|
| w⁰ | w⁰ |
| w¹ | w⁷ |
| w² | w⁶ |
| w³ | w⁵ |

To illustrate with an example, the 4^{th} and 8^{th} sums in the A region is multiplied by w² for FFTs. For IFFTs, this value becomes w⁶.

The w* multiplications are implemented as follows:

w⁰=(I+jQ)(1+j0)=I+jQ. In the w⁰ case, there is no need for modifications.

$${w}^{1} = ( I + jQ ) ( \frac{1}{\sqrt{2}} + \frac{j}{\sqrt{2}} ) .$$

In the w¹ case, a complex multiplier is required.

w² (I+jQ)(0−j1)=Q−jI. In the w² case, instead of performing a 2's complement negation for the real part of the input and then adding, the value of the real part is left unchanged and the subsequent adder is changed to a subtracter to account for the sign change.

$${w}^{3} = ( I + jQ ) ( \frac{- 1}{\sqrt{2}} - \frac{j}{\sqrt{2}} ) .$$

In the w³ case, a complex multiplier is required.

w⁴=(I+jQ)(−1+j0)=−I−jQ. The w⁴ case is not used for any FFT computations.

$${w}^{5} = ( I + jQ ) ( - 1 + \frac{j}{\sqrt{2}} ) .$$

In the w⁵ case, a complex multiplier is required.

w⁶ (I+IQ)(0+j1)=−Q+jI. In the w⁶ case, instead of performing a 2's complement negation for the imaginary part of the input and then adding, the value of the imaginary part is left unchanged and the subsequent adder is changed to a subtracter to account for the sign change.

$${w}^{7} = ( I + jQ ) ( \frac{1}{\sqrt{2}} + \frac{j}{\sqrt{2}} ) .$$

In the w⁷ case, a complex multiplier is required.

To further illustrate FIG. 7 and the duality implementations for both an FFT and an IFFT core, two sets of adders are used for the 4^{th} and 8^{th} summations. One set computes w² (FFT), while the other computes w⁶ (IFFT). A signal controls which summation to use depending on whether the FFT or the IFFT are desired. Thus, both are calculated but one used.

Real complex multipliers are required for the 6^{th} and 8^{th} values in the B region. When performing an FFT, these will be w¹ and w³. When performing an IFFT, these will be w⁷ and w⁵, respectively. The

$$\frac{1}{\sqrt{2}}$$

may be factored out to produce Equation Set 2:

$$P = \frac{1}{\sqrt{2}} \\ {w}^{1} = PI + PQ + j ( - PI + PQ ) \\ {w}^{7} = PI - PQ + j ( PI + PQ ) \qquad ( 2 )$$

A FFT/IFFT signal is used to steer the input values to the adder and subtracter, and to steer the sum and difference to their final destination. Factoring out P shows that this implementation requires two multipliers and two adders (one adder and one subtracter).

The same can be done for w³/w⁷ (Equation Set 3):

$$P = \frac{1}{\sqrt{2}} \\ {w}^{3} = - PI + PQ + j ( - PI - PQ ) \\ {w}^{5} = - PI - PQ + j ( PI - PQ ) \qquad ( 3 )$$

Instead of using P, the core uses

$$R = \frac{- 1}{\sqrt{2}}$$

for these product sums. Using R, the equations then become (Equation Set 4):
w³=RI−RQ+j(RI+RQ) (4)
w⁵=RI+RQ+j(−RI+RQ)

As before, a FFT/IFFT signal is used to steer the input values to the adder and subtracter, as well as the sum and difference to their final destination. Two multiplier and two adders (one adder and one subtracter) are required.

The trivial multiplications, w² and w⁶ in region B, are handled in the same manner as those in region A.

Depending on the embodiment and the hardware constraints, if timing constraints so requires it, these computations can be done in multiple clock cycles. A can be added to capture the Out4 values. The Out4 values for the 6^{th} and 8^{th} are multiplied by the constants P and R prior to being registered (Equation Sets 2 and 4). This placement of the registers balances the computations for the worst-case paths as follows:
1^{st} cycle: multiplexer→adder→adder→multiplexer→multiplier
2^{nd} cycle: adder→multiplexer→adder→adder

A signal is used to send out either the Out4 or Out8 values. The signal determines whether a radix-4 or radix-8 operation was required. Recall from paragraph 00032 that the FFT architecture can be implemented in different stage combinations. In the example of an 8×8×8×4 sequence, the Out4 is used for 2048 point I/FFT operations (i.e. the fourth stage of an 8×8×8×4 sequence).

FIG. 8 are diagrams of a transpose memory multiplication order 800 for the 512 point radix-8 FFT. Recall that each DFT is a combination of smaller DFTs (sDFT) into a larger DFT (lDFT). This is the essence of the butterfly computations. Although not an problem initially, subsequent sDFTs depend on outputs from previous sDFTs. This creates delays while the processor or FFTe waits for dependent input data to finish computing. By arranging the order with which these sDFTs are computed, an FFT pipeline may be implemented so as to minimize delays and producing the entire FFT in minimal time.

FIG. 8 shows the grouping for an optimal ordering 800 of sDFTs. The computations for each cell is shown and grouped. Table 2 details the specific row and column in memory from which inputs of X(k) are derived.

TABLE 2

| | | Column (samples in each row) | | | | | | | |
|---|---|---|---|---|---|---|---|---|---|
| | | 0 | 1 | 2 | 3 | 4 | 5 | 6 | 7 |
| Row | 0 | X(0) | X(1) | X(2) | X(3) | X(4) | X(5) | X(6) | X(7) |
| (row in | 1 | X(8) | X(9) | X(10) | X(11) | X(12) | X(13) | X(14) | X(15) |
| memory) | 2 | X(16) | X(17) | X(18) | X(19) | X(20) | X(21) | X(22) | X(23) |
| | 3 | X(24) | X(25) | X(26) | X(27) | X(28) | X(29) | X(30) | X(31) |
| | 4 | X(32) | X(33) | X(34) | X(35) | X(36) | X(37) | X(38) | X(39) |
| | 5 | X(40) | X(41) | X(42) | X(43) | X(44) | X(45) | X(46) | X(47) |
| | 6 | X(48) | X(49) | X(50) | X(51) | X(52) | X(53) | X(54) | X(55) |
| | 7 | X(56) | X(57) | X(58) | X(59) | X(60) | X(61) | X(62) | X(63) |

Each X(n) denotes an 8-point FFT.

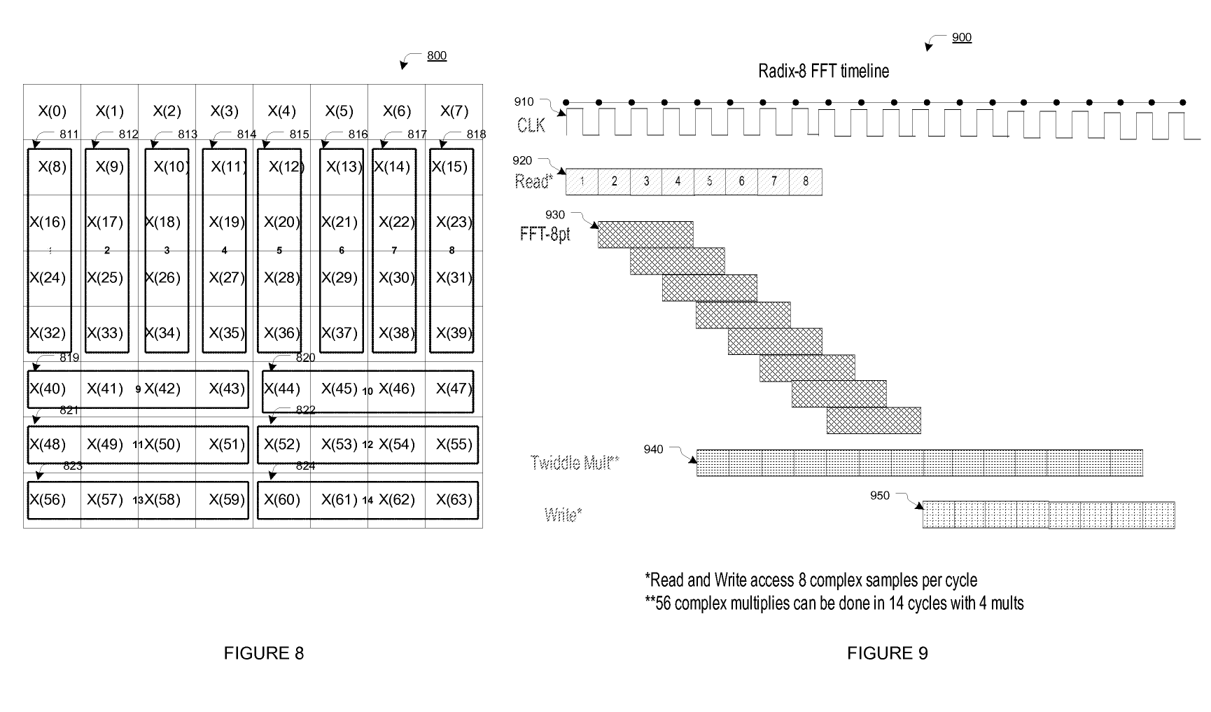

FIG. 9 is a diagram of a radix-8 FFT computation timeline 900. The clock cycles required to execute the radix-8 FFT and the order in which the operations are executed are shown over a time domain. The radix-8 FFT computation in the FFTe involves four sets of operations: reading the samples, calculating 8-point FFTs, twiddle multiply, and writing the outputs.

Because FIGS. 8 and 9 are closely related and are most easily understood together, they will be described herein together. In FIG. 9, the FFT timeline shows time increasing to the right. Discrete intervals of time are annotated with a graph of CLK 910 over time. Each complete cycle of the square wave denotes a reference time unit. In this instance, the reference time unit is calibrated to coincide with a time interval sufficient to complete a read and a write access of 8 complex samples. The read graph 920 denotes the reading of a sample. Each read box represents the time required to complete a particular read task, generally one read of 8 complex samples. The FFT-8pt graph 930 denotes the computation of 8-point FFTs, which includes the butterfly computations. Each FFT-8pt box represents the time required to complete processing a particular grouping of 8-point FFT represented by the box. 8-point FFTs are grouped based on any additional twiddle computations remaining. In some cases, completing the 8-point FFT is insufficient because twiddle multiplication is still needed. The Twiddle Mult graph 940 denotes the computation of the twiddle multiplications on the 8-point FFT group. Each twiddle mult box represents the time required to complete processing a particular twiddle multiplication represented by the box. Lastly, the write graph 950 denotes the writing of a final output into the data store. Each write box represents the time required to complete a particular write task, generally one write of 8 complex samples.

At cycle 0, eight rows of memory are read. As each of the 8 values in those rows are processed, they are written in to columns of the transposition registers. The memory values, denoted X(0) through X(7) in FIG. 8 are the first 8 values read from the first row. At cycle 4, the first column of the transposition registers are written, denoted X(0), X(8), X(16), . . . X(56) in FIG. 8. The first 4 twiddle coefficients fetch correspond to the 4 values in group 811, specifically X(8), X(16), X(24), and X(32).

While these first 4 values are twiddle multiplied, the butterfly is outputting results for the second row of memory read. These 8 values are written in to the second column of the transposition registers. The second set of twiddle coefficients fetch are for group 812, specifically X(9), X(17), X(25), and X(33).

The twiddle multiplications in groups 811 through 824 can occur as soon as butterfly results became available. Subsequently, in groups 811 through 824, the rows of transposition registers are ready to write back to the rows of memory as soon as results are available. For example, the first row of memory written will be for the X(0) through X(7) values.

After 8 rows of memory have been read and written, the next set of 8 rows are processed similarly. This occurs 8 times, completing 64 rows of memory (each holding 8 samples), for a total of 512 samples done.

In some embodiments, the values are not transposed from row to column. For different FFT stages, the row of memory written may be from a row or from a column of transposition register values. The normalization register may receive a row or a column of data from the transposition registers, perform its normalization operation as necessary, and write the values to a row of memory.

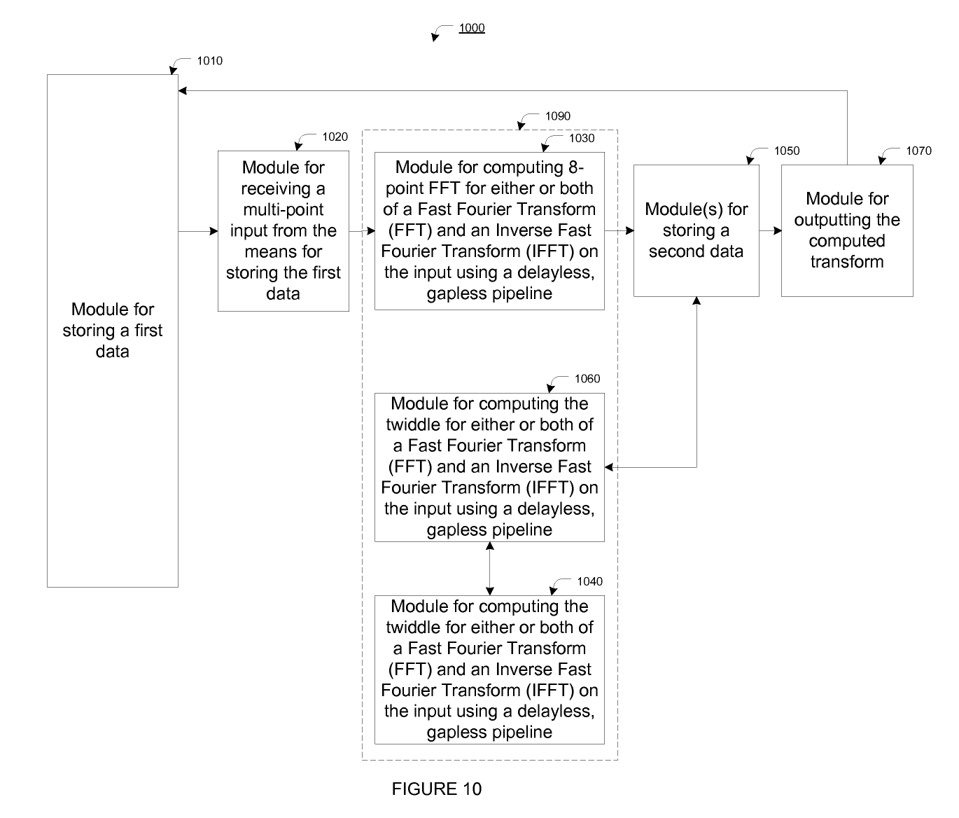

FIG. 10 shows a block diagram design of another exemplary implementation of the I/FFT engine 1000. The components illustrated in FIGS. 1-6 can be implemented by modules as shown here in FIG. 10. The information flow between these modules is similar to FIGS. 1-6. As a modular implementation 1000, the processing system 1000 comprises a module 1010 for storing a first data, one or more modules 1050 for storing a second data, the module for storing a second data being faster than the module for storing the first data, a module 1020 for receiving a multi-point input from the means for storing the first data, a module 1050 for storing the received input in at least one of the one or more modules for storing a second data, a module 1090 for computing either or both of a Fast Fourier Transform (FFT) and an Inverse Fast Fourier Transform (IFFT) on the input using a delayless pipeline. Each of these modules may be implemented within a single module or using multiple sub-modules. These modules may be further combined to form larger modules.

In some embodiments, the computation module 1090 for computing either or both of a Fast Fourier Transform (FFT) and an Inverse Fast Fourier Transform (IFFT) on the input uses a gapless pipeline. The computation module 1090 may further process the data using a radix-8 butterfly core. The storage module 1050 may store the received input in at least 64 modules for storing a second data. The computation module 1090 may compute complex multipliers, wherein 56 of the at least 64 modules 1050 for storing a second data receives input from a module 1060 for computing complex multipliers. The receiving module 1020 may receive input from the module 1010 storing a first data wherein 32 of the modules 1050 for storing the received input in at least one of the one or more modules 1050 for storing a second data. The receiving module 1020 may receive a 512-point input from the module 1010 for storing the first data. The output module 1070 may output the computed transform. The computation module 1090 may compute either or both of a Fast Fourier Transform (FFT) and an Inverse Fast Fourier Transform (IFFT) on the input using a delayless pipeline, the FFTe is configured to begin writing the output 12 cycles (8+pipeline delays) after reading the first input. In other embodiments where the pipeline delays are shorter than 4 cycles, the FFTe is configured to begin writing the output (8+pipeline delays) cycles after reading the first input.

As can be seen in FIG. 9, this implementation of this FFT pipeline is gapless. If each process 920 930 940 and 950 is considered a separate thread or engine, for a given radix-8 FFT and a given FFTe design, the time between when the thread starts processing the first subtask and when the entire task is completed is a minimum. Thus, there is no unnecessary idling of the thread/engine. Although a user may intentionally introduce gaps into the processor/thread for whatever reason (i.e. reduce processor heat, reduce processor load, and so on), if these intentionally introduced gaps are removed, the thread would be reduced to the thread described above.

To illustrate this property of the gapless pipelined FFT, in the example of the read process 920, the first sub-read (reading of X(0)) starts at cycle 0 and the last sub-read (reading of X(7)) ends at the end of cycle 7. Since there are eight reads total (X(1)-X(7)), if each sub-read starts during a different cycle, the minimum time required to read all eight rows of memory is 8 cycles, the exact time used by the read process 920 described.

To illustrate with another example, consider the FFT-8pt process 930. The first sub-FFT processing (X(0)) starts at cycle 1 and the last sub-FFT processing (X(7)) ends at the end of cycle 11. Since there are eight rows of memory, if each sub-FFT-processing starts during a different cycle, the minimum time required to FFT process all eight rows of memory is 10 cycles (8 rows of memory, each sub-FFT processing requires 3 cycles), the exact time used by the FFT-8pt process 930 described.

Next, consider the twiddle mult process 940. A radix-8 FFT requires 14 twiddle multiplications. The first sub-twiddle multiplication (group 1 811) starts at cycle 3 and the last sub-twiddle multiplication (group 14 824) ends at the end of cycle 18. Since there are 14 twiddle multiplication groups, if each sub-twiddle multiplication starts during a different cycle, the minimum time required to twiddle multiply all 14 groups is 16 cycles (14 groups, each sub-twiddle multiplication requires 3 cycles), the exact time used by the Twiddle Mult process 940 described.

Lastly, consider the write process 950. A radix-8 FFT requires 8 writes. The first sub-write (output 0) starts at cycle 12 (8+pipeline delays) and the last sub-write (output 7) ends at the end of cycle 20 (16+pipeline delays). Since there are 8 writes, if each sub-write starts during a different cycle, the minimum time required to write all eight groups is 8 cycles (8 outputs, each sub-write requires 2 cycles), the exact time used by the write process 950 described.

In the case of a multi-core or multi-processor system, some subtasks may execute during the same “real world” time cycle. However, this analysis and approach extends into these multi-core domains because all multithreaded system can be linearlized into a single thread. Reading eight rows of memory in a dual core system over the span of 4 cycles is still gapless. When the process of the dual core is linearized into a single core, the read would require 8 cycles as before.

Further, this implementation of this FFT pipeline is delayless. If each process 920 930 940 and 950 is considered a separate thread or engine, for a given radix-8 FFT and a given FFTe design, the overall time between the FFT process starting the first read and the FFT process starting the first write is a minimum. Although a user may intentionally introduce gaps into the radix-8 FFT processing for whatever reason (i.e. reduce processor heat, reduce processor load, and so on), if these intentionally introduced gaps are removed, the radix-8 FFT processing would be reduced to the radix-8 FFT processing disclosed above.

To illustrate this property of the delayless pipelined FFT, in the example of executing a radix-8 FFT, the first write cannot execute until the last 8-point FFT has completed. In turn, the last 8-point FFT cannot execute until the last row of memory has been read. Since there are 8 rows, the minimum cycles required between the first read and the first write is 12 cycles (8 reading, 3 FFT-8pt, 1 write; 8+pipeline delays), which is the scenario as disclosed above.

The clock cycle described above is processor and system clock independent. Because various processors implement commands different, one processor may require 2 processor clocks to execute a read whereas another may require 3. Although a number of operations described routines in cycles, emphasis is placed on the order of the FFT subroutines, which is system independent.

The FFT processing techniques described herein may be implemented by various means. For example, these techniques may be implemented in hardware, firmware, software, or a combination thereof. For a hardware implementation, the processing units used to perform FFT may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the techniques may be implemented with modules (e.g., procedures, functions, and so on) that perform the functions described herein. The firmware and/or software codes may be stored in a memory and executed by a processor. The memory may be implemented within the processor or external to the processor.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An apparatus comprising:
a memory; and
a Fast Fourier Transform engine (FFTe) having one or more registers and a delayless pipeline, the FFTe configured to receive a multi-point input from the main memory, store the received input in at least one of the one or more registers, and compute either or both of a Fast Fourier Transform (FFT) and an Inverse Fast Fourier Transform (IFFT) on the input using the delayless pipeline.

2. The apparatus in claim 1 wherein the pipeline is gapless.

3. The apparatus in claim 1 wherein the FFTe is a radix-8 butterfly core.

4. The apparatus in claim 1 wherein the FFTe is a radix-4 butterfly core.

5. The apparatus in claim 1 wherein the FFTe has at least 64 registers.

6. The apparatus in claim 5 further comprising complex multipliers, wherein 56 registers of the at least 64 registers receive input from the complex multipliers.

7. The apparatus in claim 5 wherein 32 registers of the at least 64 registers receive input from the main memory.

8. The apparatus in claim 1 wherein the FFTe is configured to receive a z point multi-point input, wherein z is a multiple of 512.

9. The apparatus in claim 1 wherein the FFTe is further configured to output the computed transform.

10. The apparatus in claim 9 wherein the FFTe is configured to begin writing the output x cycles after reading the first input, wherein x is 8 plus a pipeline delay.

11. The apparatus in claim 9 wherein the FFTe is configured to complete writing the output y cycles after reading the first input, wherein y is 16 plus a pipeline delay.

12. The apparatus in claim 1 wherein the FFTe includes a first set of adders configured to read a first set of inputs, and the first inputs are bit-reversed prior to the reading by the first set of adders.

13. A Fast Fourier Transform engine (FFTe) configured:
to receive a multi-point input from the main memory;
to store the received input in at least one of one or more registers; and
to compute either or both of a Fast Fourier Transform (FFT) and an Inverse Fast Fourier Transform (IFFT) on the input using a delayless pipeline.

14. The FFTe in claim 13 wherein:
the FFTe is further configured to compute either or both of a Fast Fourier Transform (FFT) and an Inverse Fast Fourier Transform (IFFT) on the input using a gapless pipeline.

15. The FFTe in claim 13 wherein:
the FFTe is further configured to compute either or both of a Fast Fourier Transform (FFT) and an Inverse Fast Fourier Transform (IFFT) using a radix-8 butterfly core.

16. The FFTe in claim 13 wherein:
the FFTe is further configured to compute either or both of a Fast Fourier Transform (FFT) and an Inverse Fast Fourier Transform (IFFT) using a radix-4 butterfly core.

17. The FFTe in claim 13 wherein:
the FFTe is further configured to store the received input in at least 64 registers.

18. The FFTe in claim 17 wherein:
the FFTe is further configured to store the received input from complex multipliers, wherein 56 registers of the at least 64 registers receive input from the complex multipliers.

19. The FFTe in claim 17 wherein:
the FFTe is further configured to store the received input from the main memory in 32 registers of the at least 64 registers.

20. The FFTe in claim 13 wherein:
the FFTe is further configured to receive a z point multi-point input, wherein z is a multiple of 512.

21. The FFTe in claim 13 wherein:
the FFTe is further configured to output the computed transform.

22. The FFTe in claim 21 wherein:
the FFTe is further configured to begin writing the output x cycles after reading the first input, wherein x is 8 plus a pipeline delay.

23. The FFTe in claim 21 wherein:
the FFTe is further configured to complete writing the output y cycles after reading the first input, wherein y is 16 plus a pipeline delay.

24. The FFTe in claim 13 wherein the FFTe includes a first set of adders configured to read a first set of inputs, and the first inputs are bit-reversed prior to the reading by the first set of adders.

25. A method comprising:
providing a memory;
providing a Fast Fourier Transform engine (FFTe) having one or more registers and a delayless pipeline;
configuring the FFTe to receive a multi-point input from the main memory;
storing the received input in at least one of the one or more registers; and
computing either or both of a Fast Fourier Transform (FFT) and an Inverse Fast Fourier Transform (IFFT) on the input using the delayless pipeline.

26. The method in claim 25 wherein:
providing the FFTe further comprises providing a gapless pipeline.

27. The method in claim 25 wherein:
providing the FFTe comprises providing a radix-8 butterfly core.

28. The method in claim 25 wherein:
providing the FFTe comprises providing a radix-4 butterfly core.

29. The method in claim 25 wherein:
providing the FFTe comprises providing at least 64 registers.

30. The method in claim 29 wherein:
providing the FFTe further comprises providing complex multipliers, wherein 56 registers of the at least 64 registers receive input from the complex multipliers.

31. The method in claim 29 wherein:
providing the FFTe comprises providing 32 registers of the at least 64 registers to receive input from the main memory.

32. The method in claim 25 wherein:
configuring the FFTe to receive a multi-point input comprises configuring the FFTe to receive a z point multi-point input, wherein z is a multiple of 512.

33. The method in claim 25 wherein:
configuring the FFTe further comprises outputting the computed transform.

34. The method in claim 33 wherein:
configuring the FFTe comprises begin writing the output x cycles after reading the first input, wherein x is 8 plus a pipeline delay.

35. The method in claim 33 wherein:
configuring the FFTe comprises complete writing the output y cycles after reading the first input, wherein y is 16 plus a pipeline delay.

36. The method in claim 25 wherein:
providing the FFTe further comprises including a first set of adders configured to read a first set of inputs, and the first inputs are bit-reversed prior to the reading by the first set of adders.

37. A processing system comprising:
means for storing a first data;
one or more means for storing a second data faster than the means for storing the first data;
means for receiving a multi-point input from the means for storing the first data;
means for storing the received input in at least one of the one or more means for storing a second data; and
means for computing either or both of a Fast Fourier Transform (FFT) and an Inverse Fast Fourier Transform (IFFT) on the input using a delayless pipeline.

38. A processing system in claim 37, further comprising:
means for computing either or both of a Fast Fourier Transform (FFT) and an Inverse Fast Fourier Transform (IFFT) on the input using a gapless pipeline.

39. A processing system in claim 37, further comprising:
means for processing the data using a radix-8 butterfly core.

40. A processing system in claim 37, further comprising:
means for processing the data using a radix-4 butterfly core.

41. A processing system in claim 37, further comprising:
means for storing the received input in at least 64 of the means for storing a second data.

42. A processing system in claim 41, further comprising:
means for computing complex multipliers, wherein 56 of the at least 64 the means for storing a second data receives input from the means for computing complex multipliers.

43. A processing system in claim 41, further comprising:
means for receiving input from the means for storing a first data wherein 32 of the means for storing the received input in at least one of the one or more means for storing a second data.

44. A processing system in claim 37, further comprising:
means for receiving a 512-point input from the means for storing the first data.

45. A processing system in claim 37, further comprising:
means for outputting the computed transform.

46. A processing system in claim 45, further comprising:
means for computing either or both of a Fast Fourier Transform (FFT) and an Inverse Fast Fourier Transform (IFFT) on the input using a delayless pipeline, the FFTe is configured to begin writing the output x cycles after reading the first input, wherein x is 8 plus a pipeline delay.

47. A processing system in claim 45, further comprising:
means for computing either or both of a Fast Fourier Transform (FFT) and an Inverse Fast Fourier Transform (IFFT) on the input using a delayless pipeline, the FFTe is configured to complete writing the output y cycles after reading the first input, wherein y is 16 plus a pipeline delay.

48. A processing system in claim 37, further comprising:
means for computing either or both of a Fast Fourier Transform (FFT) and an Inverse Fast Fourier Transform (IFFT) on the input using a delayless pipeline, the FFTe is configured to include a first set of adders, the first set of adders configured to read a first set of inputs, and the first inputs are bit-reversed prior to the reading by the first set of adders.

49. Computer readable media containing a set of instructions for a I/FFT processor to perform a method of computing an I/FFT, the instructions comprising:
a routine to receive a multi-point input from the main memory;
a routine to store the received input in at least one of one or more registers; and
a routine to compute either or both of a Fast Fourier Transform (FFT) and an Inverse Fast Fourier Transform (IFFT) on the input using a delayless pipeline.

50. The computer readable media in claim 49 wherein:
the FFTe is further configured to compute either or both of a Fast Fourier Transform (FFT) and an Inverse Fast Fourier Transform (IFFT) on the input using a gapless pipeline.

51. The computer readable media in claim 49 wherein:
the FFTe is further configured to compute either or both of a Fast Fourier Transform (FFT) and an Inverse Fast Fourier Transform (IFFT) using a radix-8 butterfly core.

52. The computer readable media in claim 49 wherein:
the FFTe is further configured to compute either or both of a Fast Fourier Transform (FFT) and an Inverse Fast Fourier Transform (IFFT) using a radix-4 butterfly core.

53. The computer readable media in claim 49 wherein:
the FFTe is further configured to store the received input in at least 64 registers.

54. The computer readable media in claim 53 wherein:
the FFTe is further configured to store the received input from complex multipliers, wherein 56 registers of the at least 64 registers receive input from the complex multipliers.

55. The computer readable media in claim 53 wherein:
the FFTe is further configured to store the received input from the main memory in 32 registers of the at least 64 registers.

56. The computer readable media in claim 49 wherein:
the FFTe is further configured to receive a z point multi-point input, wherein z is a multiple of 512.

57. The computer readable media in claim 49 wherein:
the FFTe is further configured to output the computed transform.

58. The computer readable media in claim 57 wherein:
the FFTe is further configured to begin writing the output x cycles after reading the first input, wherein x is 8 plus a pipeline delay.

59. The computer readable media in claim 57 wherein:
the FFTe is further configured to complete writing the output y cycles after reading the first input, wherein y is 16 plus a pipeline delay.

60. The computer readable media in claim 49 wherein the FFTe includes a first set of adders configured to read a first set of inputs, and the first inputs are bit-reversed prior to the reading by the first set of adders.
